(19) United States
(12) Patent Application Publication
(10) Pub. No.: US 2017/0023257 A1
(43) Pub. Date: Jan. 26, 2017

(54) Toy Baking Oven

(71) Applicant: WickedCool LLC, Bristol, PA (US)

(72) Inventors: John (Jason) Carlisle Arnold, IV, Philadelphia, PA (US); Daniel Shanahan, Philadelphia, PA (US); Jeremy Fallis, Bethkehem, PA (US); Brian Orme, Phoenixville, PA (US); Rachel Eirich, Collegeville, PA (US); Ngan King Keung, New Territories (HK); Chan Ching Yu, New Territories (HK); Yeung Po Lun, Lam Tin Kowloon (HK)

(21) Appl. No.: 14/807,422

(22) Filed: Jul. 23, 2015

(51) Int. Cl. F24C 15/00; F24C 7/06; A21B 3/07; F24C 7/04; A47J 37/01; F24C 15/04

(52) U.S. Cl. CPC F24C 15/008; A47J 37/015; F24C 15/04; A21B 3/07; F24C 7/043; F24C 7/062

(57) ABSTRACT

A toy baking oven has a housing assembly and an oven chamber positioned within the housing assembly. A light source can be carried by the housing assembly and a light pipe can be arranged between the light source and the oven chamber to direct light from the light source to the oven chamber to illuminate the interior. At least one PTC heating element can be positioned to selectively heat the interior of the oven chamber. A conveyor system can be operable between a loading region and the oven chamber. The conveyor system can have a handle on the housing exterior and a cradle within the housing assembly operable to move baking ingredients to and from the oven chamber.

### BACKGROUND

1. Field of the Disclosure

The present invention is generally directed to toy baking ovens, and more particularly to a toy baking oven with a quick heating oven chamber, a remotely illuminated oven chamber, and a conveyer assembly to deliver and withdraw baking ingredients to and from the oven chamber.

2. Description of Related Art

Well known toy baking ovens like the “Easy Bake Oven” produced by HASBRO® had long utilized an incandescent light bulb as the heating element. However, toy industry regulations have been changed. Incandescent bulb type heating elements can no longer be used as the heating element for such toy ovens as a result of such changes. Toy oven manufactures, such as HASBRO®, have had to change from using an incandescent bulb heating element to using another type of heating element in order to meet the new standards. Toy baking ovens now typically employ a wire filament type heating element to bake ingredients while still meeting the new standards. Because of safety concerns and the nature of the wire filament type heating elements, the power input to the filament must be limited. This is intended to prevent over-heating within the oven chamber.

Other problems and disadvantages have also resulted from switching to a wire filament type heating element. Operation of the new toy ovens requires a preheat time of about 20 minutes. Such a lengthy pre-heating time can be much too long in many instances to keep a child's attention. Switching to the aforementioned wire filament type heating element has also required eliminating the viewing window that allowed children to see the ingredients as it bakes in the oven chamber. Lack of a viewing window results in an important and detrimental disconnect between children and the baking process. With no window, a child cannot see the ingredients baking in the toy oven. The viewing window was an important part of the original toy oven designs. However, adding a viewing window cannot be accomplished using the new wire filament solution. This is because of the large amount of heat that would be lost through the hole in the oven that would be needed to create the viewing window.

Existing toy baking ovens also require a child to use a push stick to push and position a pan containing baking ingredients into the oven chamber entirely from the outside of the oven housing. While the technique may be adequate, pushing the pan and ingredients all the way into the oven chamber with a push stick allows for a great deal of human error. For example, the pan often may not be properly pushed all the way into the oven chamber. Further, the child must then also remove the hot pan and baked ingredients from the oven chamber and the oven housing by pulling them out of the oven using the same push stick. This can create a risk that the child accidentally or inadvertently touches a hot internal part of the oven or touches the hot pan while withdrawing the pan and baked ingredients from the oven chamber or oven housing.

Existing toy baking ovens that utilize the wire filament heating element are considered to meet relevant safety standards. However, as noted above, in order to meet the safety requirements, the filament wire solution must be underpowered in order to do so. This results in the aforementioned longer required pre-heat time and also requires a longer baking time while using the ovens. Underpowering the heating elements also effectively prevents these types of ovens from actually reaching an effective baking temperature. Thus, the baking ingredients must be such that they are essentially hardened when “baked” instead of actually being browned and fully baked.

The HASBRO® “Easy Bake Oven” toy oven has been modified to eliminate the viewing window and to employ a wire filament type heating element. Another competing toy oven on the market is functionally the same as the new or modified “Easy Bake Oven” and is known as the “LaLaLoopsy” oven produced by MGA.

### SUMMARY

In one example according to the teachings of the present disclosure, a toy baking oven has a housing assembly, an oven chamber positioned within the housing assembly and having an interior, a light source carried by the housing assembly, and a light pipe between the light source and the oven chamber. The light pipe is arranged to direct light from the light source to the oven chamber to illuminate the interior.

In one example, the toy baking oven can have one or more heating elements positioned to selectively heat the interior of the oven chamber.

In one example, the toy baking oven can have at least one PTC heating element positioned adjacent the oven chamber.

In one example, the toy baking oven can have two PTC heating elements. One can be arranged above the interior and one can be arranged below the interior of the oven chamber.

In one example, the toy baking oven can have a transparent window on the housing assembly arranged to permit viewing the interior of the oven chamber from an exterior of the housing assembly.

In one example, the toy baking oven can have a conveyor system disposed between a loading region of the housing assembly and the interior of the oven chamber. The conveyor system can be operable to convey baking ingredients between the loading region on the housing assembly and the interior of the oven chamber.

In one example, the toy baking oven can have a conveyor system with a handle that is accessible on an exterior of the housing assembly. The handle can be slidable along a slot in the housing assembly to operate the conveyor system.

In one example, the toy baking oven can have a conveyor system with a cradle that can be movable between a loading region on the housing assembly and the interior of the oven chamber.

In one example, the toy baking oven can have a handle on an exterior of the housing assembly. The handle can be manually operable to convey baking ingredients between a loading region on the housing assembly and the interior of the oven chamber.

In one example according to the teachings of the present invention, a toy baking oven has a housing assembly, an oven chamber within the housing assembly and having an interior, and at least one PTC heating element positioned to selectively heat the interior of the oven chamber.

In one example, the toy baking oven can have at least two of the PTC heating elements. One of the PTC heating elements can be positioned above the interior of the oven chamber and one of the PTC heating elements can be positioned below the interior of the oven chamber.

In one example, the toy baking oven can have a light source carried by the housing assembly and a light pipe between the light source and the oven chamber. The light source can be arranged to direct light from the light source to the oven chamber to illuminate the interior.

In one example, the toy baking oven can have a transparent window in the housing assembly. The window can be arranged to permit visual inspection of the interior of the oven chamber from the exterior of the housing assembly.

In one example, the toy baking oven can have a conveyor system disposed between a loading region of the housing assembly and the interior of the oven chamber. The conveyor system can be operable to convey baking ingredients between the loading region and the interior.

In one example, the toy baking oven can have a conveyor system with a handle that is accessible on an exterior of the housing assembly. The handle can be slidable along a slot in the housing assembly to operate the conveyor system.

In one example, the toy baking oven can have a conveyor system with a cradle that is movable between a loading region in the housing assembly and the interior of the oven chamber.

In one example, the toy baking oven can have a handle on an exterior of the housing assembly. The handle can be manually operable to convey baking ingredients between a loading region on the housing assembly and the interior of the oven chamber.

In one example according to the teachings of the present disclosure, a toy baking oven has a housing assembly, a loading region into the housing assembly, an oven chamber within the housing assembly, and a conveyor system operable between the loading region and the oven chamber. The conveyor system has a handle on the exterior of the housing assembly and a cradle within the housing assembly. The handle is slidable along a slot in the housing assembly to convey the cradle between the loading region and the oven chamber.

In one example, the toy baking oven can have two PTC heating elements, one arrange above an interior of the oven chamber and one arranged below the interior of the oven chamber.

In one example, the toy baking oven can have a light source carried by the housing assembly and a light pipe between the light source and the oven chamber. The light source can be arranged to direct light from the light source to the oven chamber to illuminate an interior of the oven chamber.

### BRIEF DESCRIPTION OF THE DRAWINGS

Objects, features, and advantages of the present invention will become apparent upon reading the following description in conjunction with the drawing figures, in which:

FIG. 1 shows a front, top, and right side perspective view of one example of a toy baking oven constructed in accordance with the teachings of the present disclosure.

FIG. 2 shows a front view of the toy baking oven of FIG. 1.

FIG. 3 shows a left side view of the toy baking oven of FIG. 1.

FIG. 4 shows an opposite right side view of the toy baking oven of FIG. 1 and depicts an opening into a loading region of the oven.

FIG. 5 shows a back view of the toy baking oven of FIG. 1.

FIG. 6 shows an exploded view of the toy baking oven of FIG. 1.

FIG. 7 shows a perspective view of the back of the toy baking oven of FIG. 5, but with a back section of the housing assembly removed to expose a conveyor system and an oven chamber, each being shown at least partly in cross-section.

FIG. 8 shows the conveyor system of FIG. 7 including a baking pan inserted into the loading region of the oven and engaged with a cradle of the conveyor system.

FIG. 9 shows the conveyor system of FIG. 8 but with the baking pan conveyed partly along the loading region.

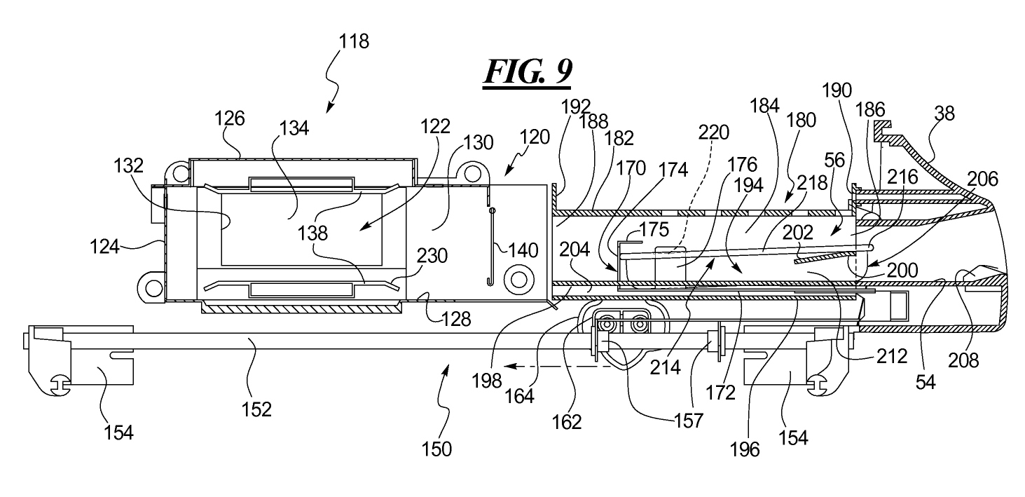

FIG. 10 shows the conveyor system of FIG. 9 but with the baking pan conveyed further along the loading region part way in the direction toward the oven chamber.

FIG. 11 shows the conveyor system of FIG. 10 but with the baking pan entering the oven chamber.

FIG. 12 shows the conveyor system of FIG. 11 but with the baking pan positioned completely in the oven chamber.

FIG. 13 shows a top view of the toy baking oven of FIG. 1 including a vented warming tray on the top of the housing assembly.

### DETAILED DESCRIPTION OF THE DISCLOSURE

The disclosed toy baking oven (hereinafter “the oven” or “the disclosed oven”) solves or improves upon one or more of the above-noted and/or other problems and disadvantages with prior known toy baking ovens. The disclosed oven utilizes heating elements that are more temperature stable than prior known heating elements in toy baking ovens. The disclosed oven utilizes heating elements that can achieve higher cooking temperatures than prior known heating elements in toy baking ovens. The disclosed oven utilizes heating elements that can achieve a target baking temperature more precisely and faster than prior known heating elements in toy baking ovens. The disclosed oven provides a window into the oven chamber through the oven housing assembly. The disclosed oven utilizes a light pipe to illuminate the oven chamber while keeping the light source remote from the oven chamber. The disclosed oven employs a conveyor system that can be easily manipulated from outside the toy baking oven. The conveyor system can maneuver baking ingredients into the oven chamber, withdraw the baked ingredients from the oven chamber, and aid in withdrawing the baked ingredients from the toy baking oven. These and other objects, features, and advantages of the disclosed toy baking oven will become apparent to those having ordinary skill in the art upon reading this disclosure.

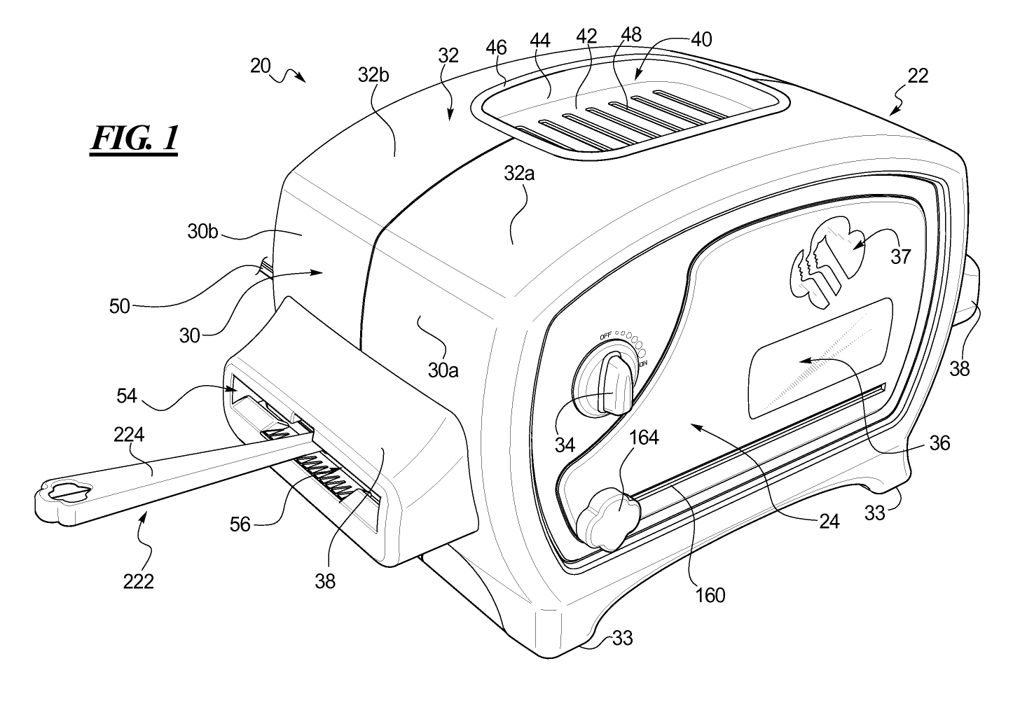

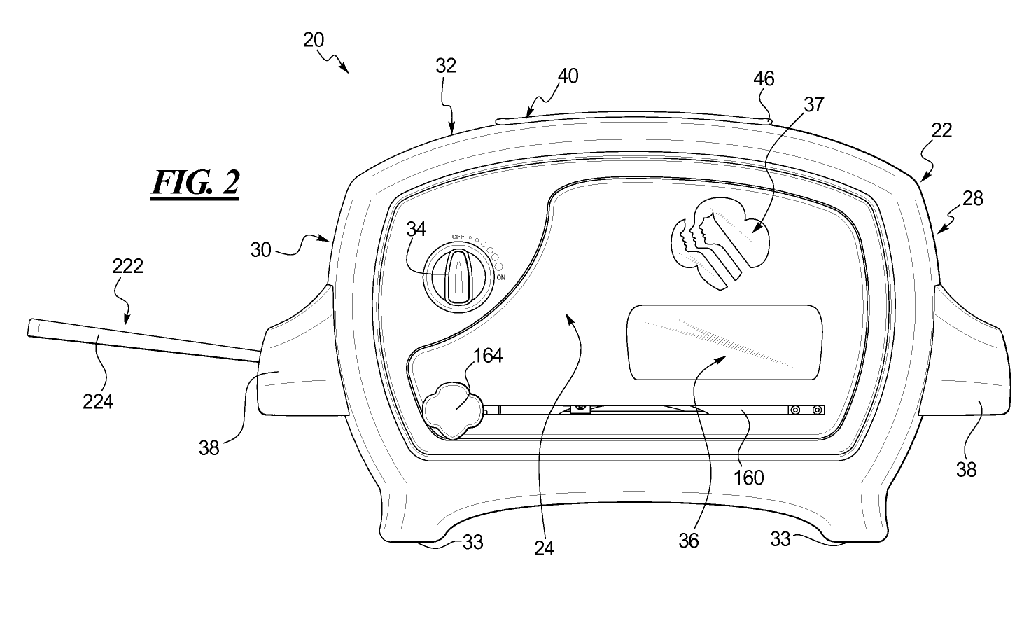

Turning now to the drawings, FIGS. 1-5 show one example of a toy baking oven 20 (hereinafter “the oven 20”) constructed in accordance with the teachings of the present disclosure. In this example, the oven 20 generally has a housing assembly 22 that defines a front 24, a back 26, a left side 28, a right side 30, a top 32, a bottom (not definitively shown), and feet 33 of the oven. As shown in FIGS. 1 and 2, the front 24 generally carries an operating element (or multiple operating elements) to operate the oven 20. The operating elements can include one or more dials, switches, sliders, knobs, or the like. In the disclosed example, the operating element is a rotatable knob 34 provided to operate the oven 20. Some details of the function of the knob 34 are described below as needed. The front 24 also has one or more transparent regions through or provided on the housing assembly 22. The transparent regions can include a window 36 in the front 24 of the housing assembly 22 to permit visibility into the oven 20, as described in greater detail below, to view and inspect ingredients that are baking. The transparent regions can also include a transparent logo 37 or other transparent section that can be back lit and illuminated while the oven 20 is operating. The transparent logo 37 can provide a desired aesthetic appearance when back lit or illuminated and/or can provide an indication to a user as to whether the oven 20 is on (illuminated) or off (not illuminated).

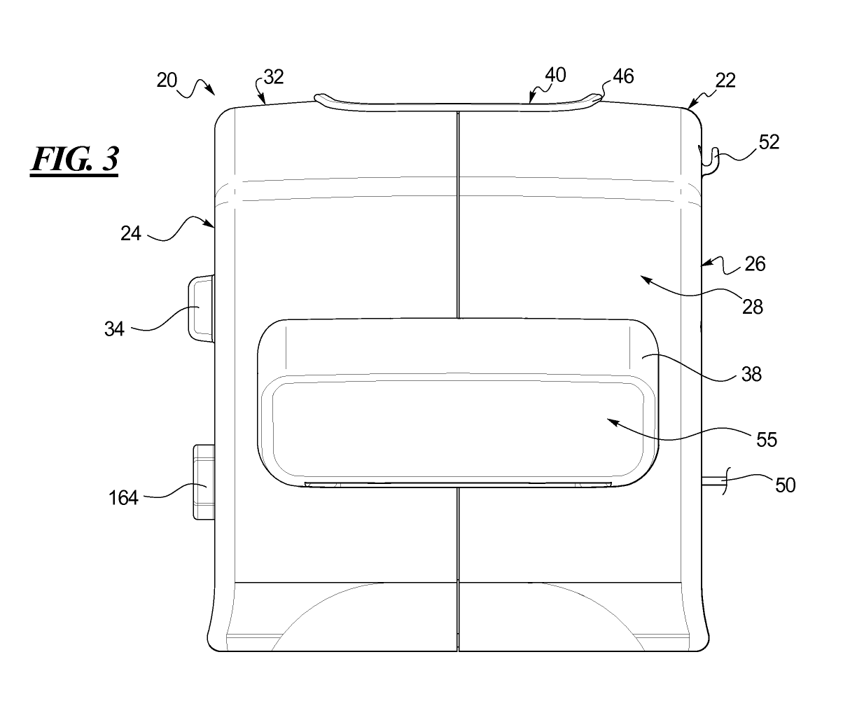

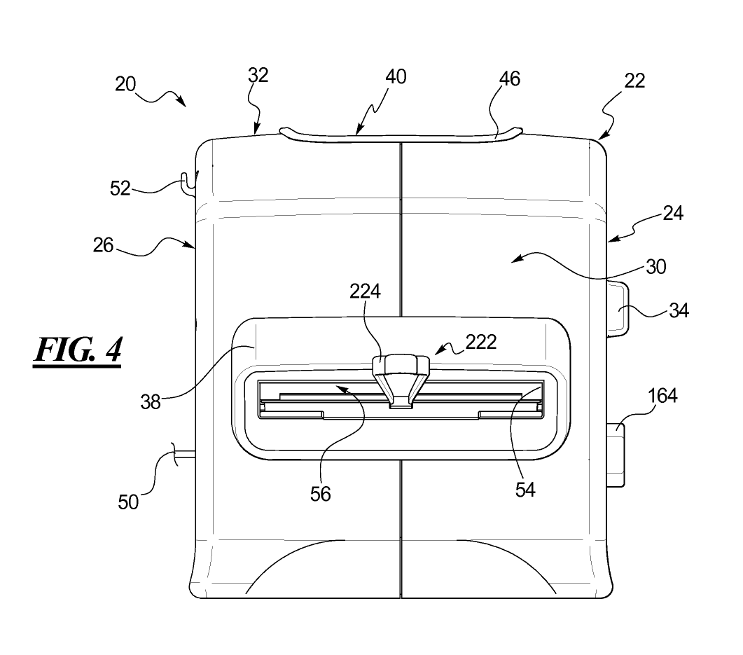

As shown in FIGS. 3 and 4, a handle 38 can be carried on each of the left and right sides 28, 30 of the housing assembly 22, as in this example. The handles 38 can be separate components that are fastened or otherwise attached to the left and right sides 28, 30 of the housing assembly 22. Alternatively, the handles 38 can be integrally formed, stamped, molded, or otherwise created as contiguous parts of the housing assembly 22, if desired. The handles 38 are positioned to allow a user to easily grasp the handles to hold and carry the oven 20. The handles 38, however, can be eliminated or can be replaced instead by a single handle or multiple handles on other portions of the oven 20, such as on the top 32 or extending above and over or across the top of the oven, if desired.

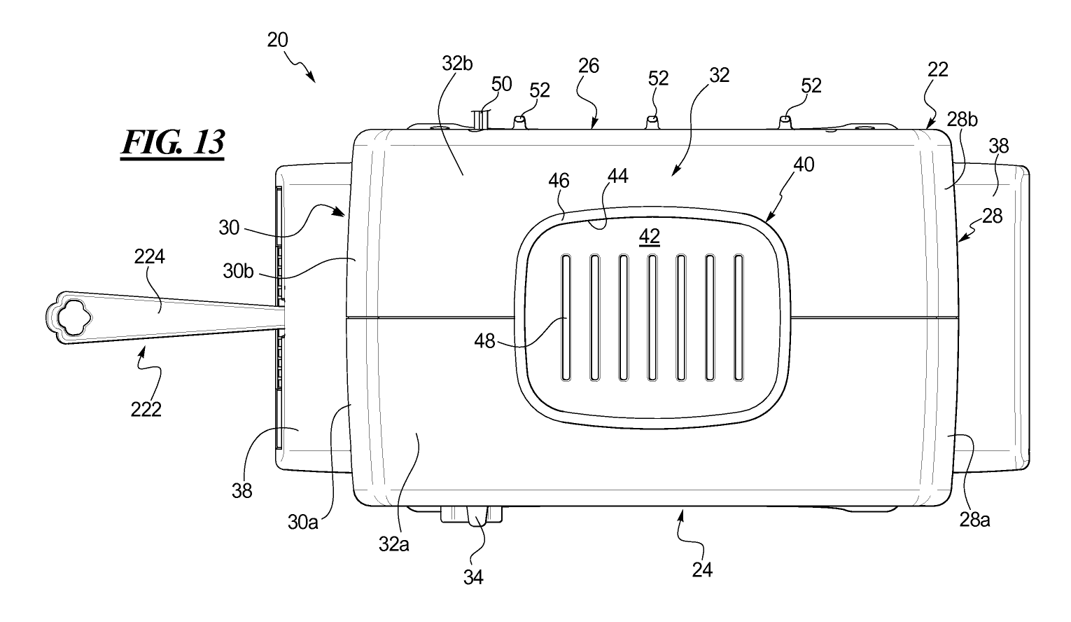

As shown in FIG. 1, (and see FIG. 13 as well), an optional recessed region can be provided in the top 32 of the oven 20, as in this example. The recessed region can be or can include an integrated tray or receptacle that is formed, stamped, molded, or otherwise created as an integral or contiguous part of the housing assembly 22. In the disclosed example, the recessed region instead is a separate tray 40 that can be either removable from the top 32 or fixedly attached to the top of the housing assembly 22. In this example, the tray 40 has a bottom panel 42, an upstanding side wall 44 surrounding the bottom panel, and a lip 46 protruding outward from a top free edge of the side wall. The bottom panel 42 of the tray 40 can include a plurality of vents 48 across a width of the tray. Further details of the tray 40 and vents 48 are also described below as needed.

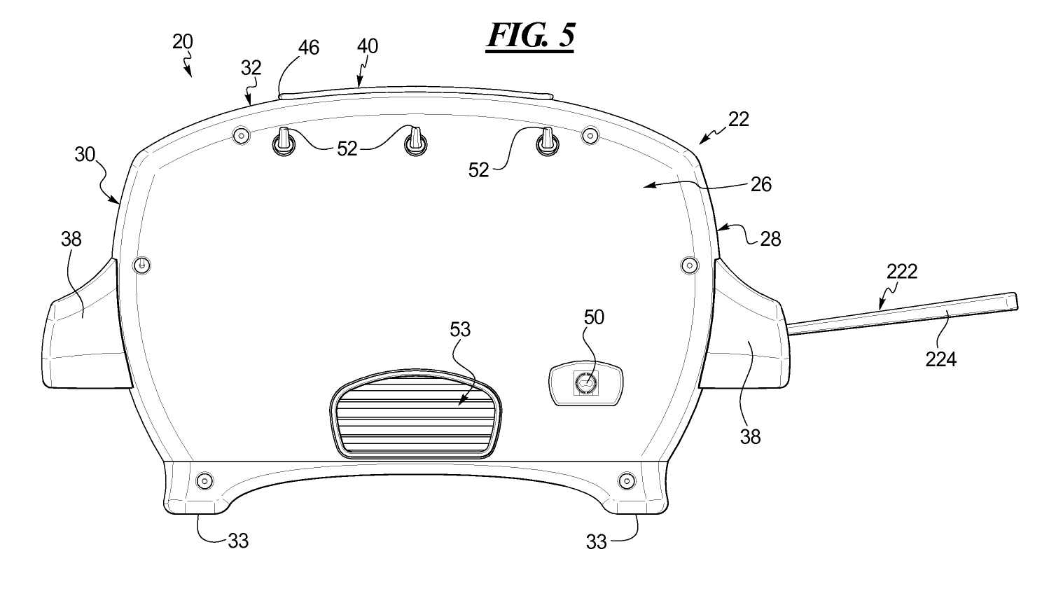

An electrical power cord 50 extends from the back 26 of the housing assembly 22 in this example, as shown in FIG. 5. The power cord 50, as is known in the art, is used to plug the oven 20 into a standard 110 volt AC outlet to power and operate some components of the oven. One or more hooks 52 can also be provided on the back 26 as shown, and/or on other parts of the housing assembly 22. The hooks 52 can be used to store accessories for the oven 20 by hanging the accessories from the hook or hooks on the oven. The hooks 52 can be snapped or otherwise fastened or attached to the housing assembly 22. Alternatively, the hooks 52 can be integrally formed as a contiguous part of the back 26 or another part of the housing assembly 22. The back 26 can also optionally have one or more vents or vent openings 53 to ventilate the oven 20, allowing warm air to escape or exit the housing assembly 22 and/or cooler air to enter.

In the disclosed example, the housing assembly 22 has an access opening 54, as shown in FIGS. 1 and 4. The access opening 54 is open to a loading/unloading zone, section, or region, hereinafter the loading region 56, within the oven 20. In this example, the access opening 54 is provided directly through the right side handle 38. However, the access opening 54 can instead be provide directly through the right side 30 of the housing assembly 22 above or below the handle 38. Alternatively, the access opening could be provided on the left side 28 or through the handle on the left side if the oven components are rearranged accordingly. In this example, the other handle 38 has a blind or closed recess 55 formed into the handle. In this example, a user can place the fingers of one hand in the recess 55 and the fingers of the other hand into the access opening 54 to lift and carry the oven 20 by both handles 38.

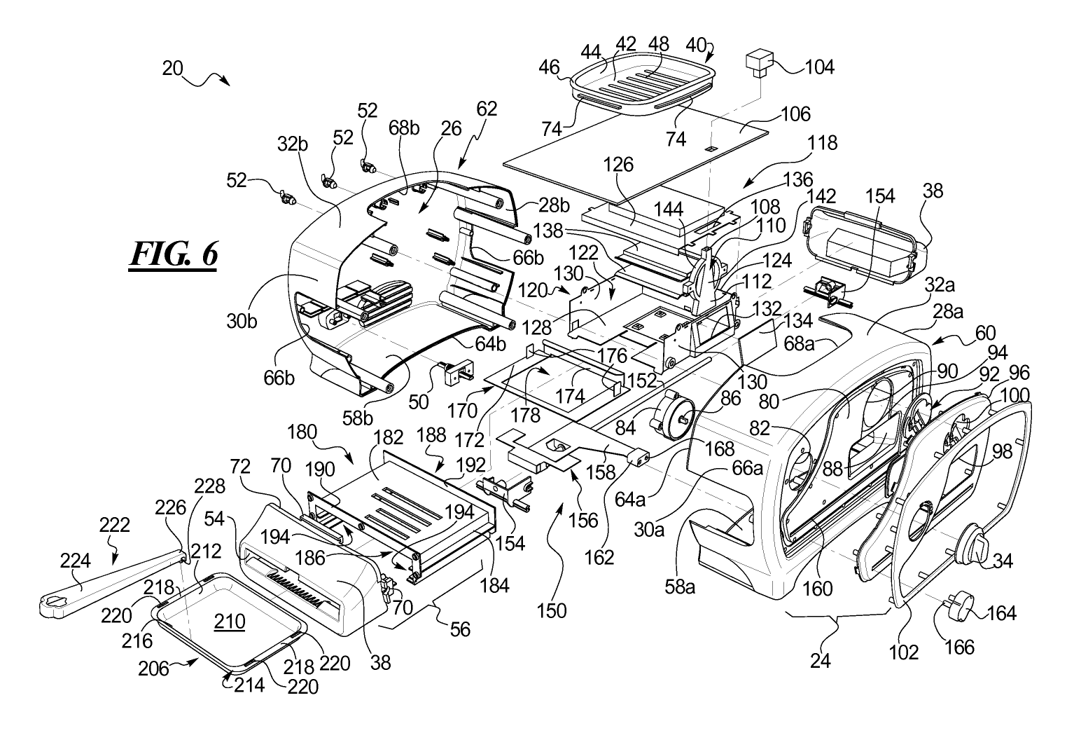

FIG. 6 shows an exploded view of the oven 20 depicting the various components of the housing assembly 22 and the internal oven components as well. In this example, the housing assembly 22 is formed having two primary parts including a front section 60 and a back section 62. The front section 60 carries the entire front 24 of the housing assembly 22 and the back section 62 carries the entire back 26 of the housing assembly. Each of the front and back sections 60, 62 also carries a left side panel segment 28a, 28b, respectively, a right side panel segment 30a, 30b, respectively, a top panel segment 32a, 32b, respectively, and a bottom panel segment 58a, 58b, respectively. The various panel segments of the front and back sections 60, 62 each have respective free edges 64a, 64b that are designed and configured to mate with one another when the front and back sections are connected. The housing sections 60, 62 can be joined using conventional fasteners (not shown) or other suitable means. When attached to one another, the left side panel segments 28a, 28b combine to form the left side 28 and the right side panel segments 30a, 30b combine to form the right side 30 of the housing assembly 22. Likewise, the top panel segments 32a, 32b form the top 30 and the bottom panel segments 58a, 58b form the bottom (not show) and the feet 33 of the housing assembly 22.

Each of the left side panel segments 28a, 28b and the right side panel segments 30a, 30b in this example defines a portion of a handle opening 66a, 66b, respectively. Each of the top panel segments 32a, 32b also defines a portion of a tray opening 68a, 68b, respectively. The handle opening portions 66a, 66b confront one another in the assembled oven 20 to define a handle opening on each of the right and left sides 28, 30 of the housing assembly 22 when assembled. Likewise, the tray opening portions 68a, 68b confront one another in the assembled oven 20 to define a tray opening on the top 32 of the housing assembly 22 when assembled.

In one example, the handles 38 can be attached to the oven 20 after the front and back sections 60, 62 are assembled. Each of the handles 38 has a body with a plurality of connectors 70 around a perimeter 72 of the body. The positioning and configuration of the connectors 70 can be designed having a snap or detent function permitting the connectors to forcibly pass through one of the handle openings and secure the handles 38 in place on the sides 28, 30 of the housing assembly 22. Alternatively, the connectors 70 can be designed so that the handles 38 must be captured between the housing sections 60, 62 as the sections are assembled to one another. Protruding portions of the connectors 70 can thus be borne against the inside surfaces around the handle openings of the sides 28, 30 of the housing assembly 22 to retain the handles 38 in place. In other alternatives, the handles 38 can be fastened to the housing assembly 22 in other suitable ways and using suitable fasteners, adhesives, molding techniques, chemical bonding, molecular bonding, heat welding, or the like.

In one example, the tray 40 can be attached after the front and back sections 60, 62 are assembled. The tray 40 can have a plurality of connectors 74 around and protruding from the exterior of the side wall 44. The connectors 74 can be appropriately spaced from the lip 46 and the connectors can be designed having a snap or detent function. The connectors 74 can be designed to thus forcibly pass through the tray opening and secure the tray 40 in place on the top 32 of the housing assembly 22. Alternatively, the connectors 74 can be designed so that the tray must be captured between the housing sections 60, 62 while the sections are assembled to one another. The connectors 74 can thus be borne against the inside surfaces of the top 32 around the tray opening of the housing assembly 22 to retain the tray 40 in place. In other alternatives, the tray 40 can be fastened to the housing assembly 22 in other suitable ways and using suitable fasteners, adhesives, molding techniques, chemical bonding, molecular bonding, heat welding, or the like.

The front and back housing sections 60, 62, the tray and handle opening portions 66a, 66b and 68a, 68b, and the tray 44 and handles 38 can vary in configuration and construction from the examples disclosed and described herein. For example, the handles can vary in size, number, shape, and location on the housing assembly 22 and can be formed from a variety of different materials and colors. Further, the tray can be eliminated, can be integral with the housing, or can be of different size, shape, color, and/or mounting location as well.

As shown in FIG. 6, the front 24 of the housing assembly 22 can have a multi-piece construction. In this example, the front 24 has a main panel 80 that is formed as an integral, contiguous part of the front section 60. The main panel 80 can have one or more holes to accommodate the one or more operating or control elements. In this example, the main panel 80 has one hole 82 to accommodate one control assembly 84, which can be a combination ON/OFF switch and timer. The control assembly 84 mounts to the inside surface of the main panel 80 adjacent and overlying the hole 82. The control assembly 84 can be coupled to and powered by the AC source in any suitable manner. The control assembly 84 can be attached to the main panel 80 by any suitable means such as fasteners, adhesives, chemical or molecular bonding, heat welding, or the like. The knob 34 can attach to a stem 86 protruding from the control assembly 84 through the hole 82.

The disclosed main panel 80 also defines both a window frame 88 and an indicator opening 90 through the front 24. A lens 92 is sized and shaped to fit over and cover both the window frame 88 and the indicator opening 90 in this example. All or part of the lens 92 is transparent and can be formed of a suitable transparent plastic material such as polycarbonate, acrylic, or the like. A recess 94 can be provided in the main panel 80 surrounding the window frame 88 and indicator hole 90. The recess 94 can be shaped to match that of the lens 92 so that the lens seats in the recess. The front 24 in this example also has a secondary panel 96 that seats over the main panel 80 and that sandwiches and captures the lens 92 therebetween. The secondary panel 96 has openings 98, 100 that align with the lens 92 and also with the window frame 88 and indicator hole 90 so that both are visible through the secondary panel. In this example, the front 24 also has a bezel 102 that attaches to the main panel 80 around a perimeter of the secondary panel. The bezel 102 can be used to secure the lens 92 and the secondary panel 96 in place on the front 24. The bezel 102 can also serve as an aesthetic or decorative function on the front 24 of the oven 20.

The configuration and construction of the front 24 can vary from the example disclosed and described herein. For example, the bezel 102, the secondary panel 96, and the main panel 80 can be shaped, configured, arranged, and colored in many different ways in order to provide a desired aesthetic appearance and/or construction and function when assembled. The arrangement of the parts can also vary when assembled. One or more of the parts can be eliminated, such as the bezel, the main panel, the secondary panel, the lens, and/or combined with one of the other components.

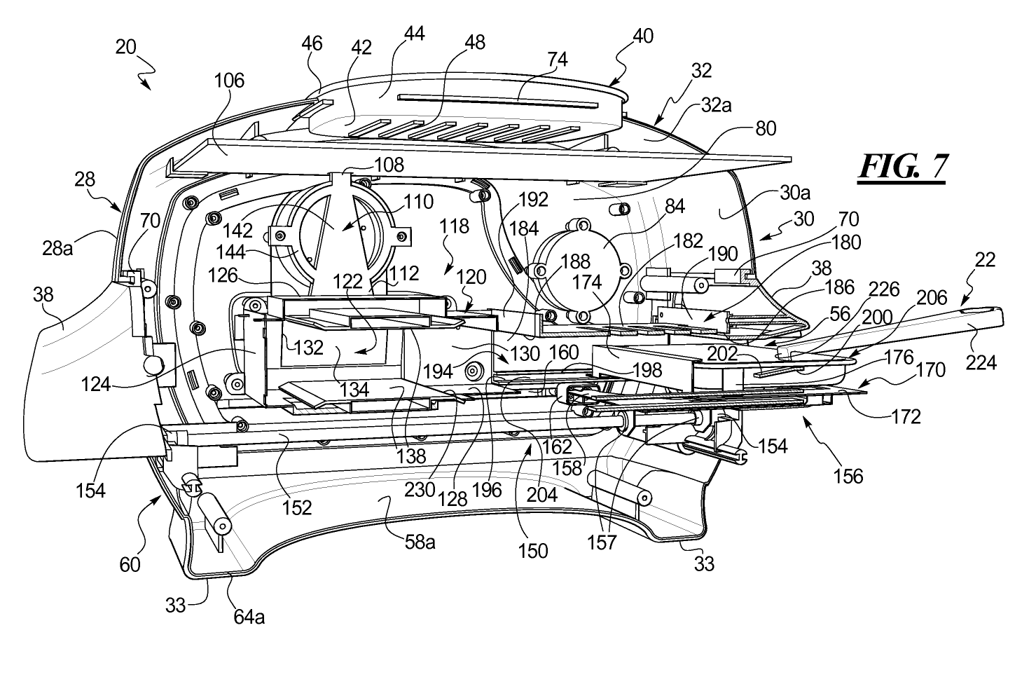

With reference to FIGS. 6 and 7, the disclosed oven 20 also has a light source 104 mounted above a heat shield 106 within the housing assembly. The light source 104 can be an LED type light source or other suitable light source, as desired. The light source 104 can be coupled to and powered by the AC source in any suitable manner. The light source 104 is coupled to an inlet end 108 of a light pipe 110. The light pipe 110 can be formed of a plastic material, such as an acrylic or polycarbonate material. The light pipe 110 can function in a known manner to deliver light from a remote source to another location by reflecting light internally from the inlet end 108 to an outlet end 112.

As shown in FIGS. 6 and 7, the disclosed oven 20 also has an oven assembly 118 within the housing assembly 22. In this example, the oven assembly 118 has an oven chamber 120 that is structured to define a substantially enclosed interior 122. The oven chamber 120 is generally a rectangular shaped box and has a back wall 124, a top wall 126, a bottom wall 128, opposed side walls 130, and an open front end that faces the loading region 56 and the access opening 54. The walls of the oven chamber 120 can be made of a suitable metal material and can be formed as one or more pieces that can be bent and/or connected to one another to create the box shape of the oven chamber. One of the side walls 130 has an opening 132 that faces in the direction of the front 24. The opening 132 can be covered by a window pane 134 attached, adhered, fastened, or otherwise connected to the oven chamber 120. The window pane 134 forms a portion of the side wall 130 and thus is directly adjacent the interior that will heat up during use of the oven 20. The window pane 134 should thus be made from a high temperature, food grade glass or plastic material, such as MAKROLON®, which is a high temperature polycarbonate material. The top wall 126 also provides an opening 136 in this example for the outlet end 112 of the light pipe. Light from the light pipe 110 can thus enter and illuminate the interior of the oven chamber 120 during use.

In the disclosed example, the oven assembly 118 also has one or more planar or plate type heating elements disposed within or directly adjacent at least one of the walls of the oven chamber 120. In this example, the oven assembly 118 employs two such heating elements, one at the top of the interior and one at the bottom of the interior of the oven chamber 120. In one example, the one or more heating elements can be a positive temperature coefficient (PTC) heating elements 138. A PTC heating element is one that is formed from or that includes at least a layer or section of a PTC material. Many metals, such as silver and gold, have PTC properties, but would be much too expensive for a toy oven and would not have the right temperature characteristics for such use. Other materials, such as ceramics can be formed to have PTC properties, such as metal oxides, metal carbides, metal nitrides, or the like. Again, some of these ceramic materials may not be particularly suitable for a children's toy baking oven but some may be perfectly well suited. Other PTC materials have also been developed and can be specifically designed to meet particular maximum temperature and cost requirements.

PTC materials experience an increase in electrical resistance when their temperature is raised. This creates a built-in maximum temperature capability. Some PTC materials show a relatively rapid increase with temperature and thus have a higher coefficient. The higher the coefficient, the greater an increase in electrical resistance for a given temperature increase. A PTC material can be designed to reach a maximum temperature for a given input voltage, since at some point any further increase in temperature would be met with greater electrical resistance. Thus, PTC materials are inherently temperature self-limiting. When the jump in resistivity in a PTC material is sufficiently high, the resistivity effectively blocks the current and thus prevents heating of the PTC material. This prevents overheating of the PTC heating elements. Products also require no additional electronic circuitry in order to control temperature in article that includes a PTC material. Upon cooling, the PTC material resets itself. As a result, PTC heating elements can be particularly well suited to use in the disclosed toy baking oven 20.

Further, thermoplastic materials can be created that have PTC characteristics. The base resin can be modified by adding an electrically conductive filler, such as a ceramic composition, carbon black, carbon fibers, graphite, carbon nanotubes, metallic fillers, or the like. Characteristics of the base resin and properties of the conductive filler (material type, amount, particle size, etc.) can be tailored to produce a PTC heating element with a desired maximum temperature and a desired maximum time period (maximum pre-heat time) to achieve the maximum temperature.

In the disclosed example, two PTC heating elements 138 are employed. The PTC heating elements 118 are a layered plate-like construction in this example. One of the heating elements 138 is positioned below the top wall 126 and the other of the heating elements 138 is positioned above the bottom wall 128 of the oven chamber. Thus, surfaces of the PTC heating elements 138 are exposed within the interior 122 of the oven chamber 120. The PTC heating elements 138 can also be coupled to and powered by the AC source in any suitable manner.

The oven assembly 118 also has an oven door 140 that hangs adjacent, i.e., in front of the open front end of the oven chamber 120. The oven door 140 is pivotally mounted so as to be able to swing open and closed. In this example, the oven door 140 can swing upward to an open position when pushed, exposing the open front end of the oven chamber 120. The oven door 140 can also swing downward under gravity to a closed position covering the open front end of the oven chamber 120. If desired, the oven door 140 can be biased to a closed position by a biasing element, such as a spring (not shown).

The configuration and construction of the oven assembly 118 can vary from the examples disclosed and described above. For example, the shape, configuration, number of pieces, and material selection can vary for the oven chamber 120. The oven chamber 120 can be made of sheet metal, steel, aluminum, metal alloys, or the like, for example. Likewise, the shape, size, configuration, material selection, and quantity of the heating elements can also vary. The PTC material can be tailored to yield desired heating times and/or maximum temperatures, as needed to meet specific design characteristics or standards.

The configuration and arrangement of light source 104, the type of light source (LED or non-LED), the material for the light pipe 110, and the size, shape, and configuration of the light pipe can also vary. In this example, the light pipe 110 has a main body 142 extending between the light inlet end 108 and the outlet end 112. The main body tapers from a narrow width near the inlet 108 to a wider width near the outlet 112. The wider outlet 112 may help to deliver a broader light beam or a less focused output to help illuminate more of the interior of the oven chamber 120, if desired. In this example, the light pipe 110 also has a ring portion 144 with portions extending from the main body 142 near the inlet end 108 and portions extending from the main body near the outlet end 112. In this example, the ring portion 144 may be provided to deliver some light from the light pipe to the indicator opening 90 and opening 100 of the front 24 to illuminate the logo region 37, if desired. In this example, the ring portion 144 is also used to mount the light pipe 110 to the inside surface of the main panel 80 of the front 24. However, many different shapes and configurations for the light pipe may be utilized within the scope of the present disclosure.

As shown in FIGS. 6 and 7, the oven 20 also has a conveyor system 150 disposed within the housing assembly 22. The conveyor system 150 in this example is a manually operated mechanism that includes a guide, rail, or track extending across the width of the interior of the housing assembly 22. The guide, rail, or track in this example is an elongate rod 152 that is supported at each of its ends by a respective mounting bracket 154. One or both of the mounting brackets 154 can be a separate component that is attached to portions of the housing assembly 22 or can be an integral, contiguous part of the housing assembly. In this example, each mounting bracket 154 is a separate part attached to the interior surfaces of each of the adjacent sides 28, 30 of the housing assembly 22. The mounting brackets 154 can be attached, fastened, adhered, bonded, welded, or otherwise secured in place.

The conveyor system 150 also has a shuttle 156 with a pair of spaced apart bearings 157 on the bottom of the shuttle. The rod 152 is received through the bearings 157 so that the shuttle 156 is mounted to and slidable along the rod 152. The shuttle 156 includes an arm 158 that protrudes forward from the shuttle and rod 152 toward the front 24 of the housing assembly 22. A slot 160 is provided across the front 24 near a lower end of the front 24 on the housing assembly 22. A connector 162 at the end of the arm 158 can extend either directly adjacent to, into, or through the slot 160 and is exposed in or near the slot. An actuator or handle 164 is connected to the connector 162. In this example, the handle 164 has prongs 166 that seat in receptacles 168 in the connector 162 to attach the handle to the shuttle 156. The prongs 166 can extend through the slot 160 in this example. A user can grasp the handle or actuator 164 and can slide the shuttle 156 along the rod 152, as described below.

In the disclosed example, a separate cradle 170 is coupled to and supported by the shuttle 156. Thus, when the shuttle 156 is moved along the rod 152, the cradle 170 is also moved along the rod. In this example, the cradle 170 has a body 172 that is a rectangular, flat ring shape. The cradle 170 has an upstanding wall 174 that protrudes up from the leading end of the body 172. A stop flange 175 at the top edge of the upstanding wall 174 protrudes back over the body of the cradle 170. A pair of cleats 176 protrude up from the body 172 on opposite sides of the body. The cleats 176 in this example are thin, tab-like protrusions. However, the cleats can be different in positioning, height, shape, quantity, and the like, if desired. The ring shaped body 172 creates a central opening 178 within the body. The cradle 170 can be joined to the shuttle 156 in any number of ways. The cradle 170 can be attached via fasteners, an adhesive, mechanical tabs, a key and way, or the like. The shuttle 156 can be configured so as to conform to the body 172 without blocking the central opening 178, at least not right at the elevation or plane of the flat body. Alternatively, the cradle can be formed as an integral contiguous part of the shuttle, if desired. In another alternative, the shuttle and cradle can simply be combined into one component that achieves both functions of cradling elements to be delivered to the oven assembly while sliding along the rod.

In the disclosed example, the loading region 56 in the housing assembly 22 can be defined by part of the conveyor system 150. As shown in FIGS. 6 and 7, the disclosed conveyor system 150 has a loading chamber 180 that is positioned adjacent the access opening 54. The loading chamber 180 has a top panel 182 and a pair of opposed side panels 184. The loading chamber 180 is open at the bottom and at an entry end 186 that is adjacent to and that faces the access opening 54. The loading chamber 180 is also open at a discharge end 188 opposite the entry end 186. The loading chamber 180 can be formed from the same or similar materials as the earlier described oven chamber 120.

In this example, a flange 190 surrounds the entry end 186 of the loading chamber 180. The flange 190 can be used to fasten the loading chamber 180 to part of the handle 38, the side 30, or both in order to secure the loading chamber in place. The discharge end 188 of the loading chamber 180 also has a flange 192 that can be used to attach the loading chamber to the oven assembly 118, the housing sections 60, 62, or both. The loading chamber 180 can vary in size, shape, configuration, material selection, and construction from the example disclosed and described herein. In other examples, the loading chamber may be eliminated altogether and/or can be combined with the cradle and/or the shuttle into a single component that performs the functions of both or all three components.

A guide 194 for the conveyor system 150 protrudes inward from each of the side panels 184 on the loading chamber 180. Each guide 194 has three flanges that protrude inward toward the opposite side panel 184 and each minors a sister flange on the opposite side panel. A first flange 196 of the three flanges is positioned at or near the lower end of each of the side panels 184 and extends the length of the loading chamber 180. A second flange 198 is positioned closely spaced from and above the first flange 196 on each of the side panels 184 and extends the length of the loading chamber 180. A third flange 200 is positioned spaced further above the second flange 198 on each of the side panels near the entry end 186 of the loading chamber 180. The third flange 200 extends from the entry end 186 only part way along the length of the loading chamber, as shown in FIG. 7, and has a downwardly ramped trailing end 202. A cradle track 204 is defined between the first and second flanges 196, 198 on each side panel 184. The third flange 200 supports and guides a baking pan 206 during insertion or loading of the pan 206 into the oven 20, as described below, in combination with one or more ramps 208 positioned within the access opening 54 in the handle 38.

The baking pan 206 is shown in FIG. 6 and has a rectangular baking surface 210 surrounded by an upstanding rectangular, perimeter wall 212. The wall 212 has an outward extending rim 214 around the baking pan 206. The rim 214 is short, i.e., has a relatively shallow projection dimension along the leading and trailing sections 216 of the rim. The rim 216 is longer, i.e., has a deeper projection dimension along the side sections 218 of the rim. The rim 216 also includes a slot 220 near each corner of the baking pan 206. The slots 220 are disposed in the wider rim side sections 218. The slots 216 are configured, located, and oriented to engage the cleats 176 of the cradle 170, as described in greater detail below, with the baking pan 206 in a width-wise orientation. The baking pan 206 has a width that allows it to closely fit the width of the access opening 54 and the loading chamber 180. The baking pan 206 in this example has a shorter length than width merely to fit the size of the oven chamber 120. The baking pan 206 can have a different size and/or shape and can be longer than it is wide. The slots 220 are sized and oriented so that they can only engage the cleats 176 when the baking pan 206 is properly width-wise oriented during loading. Other than the size of the baking pan 206, the shape and orientation of the cleats 176 and slots 220 can prevent a user from improperly loading the baking pan 206 into the oven 20. The baking pan can vary in size, shape, and configuration from the example disclosed and described herein, as can the rim and slots. Other mechanisms different from the cleats and slots can also be used to create engagement between the baking pan and conveyor system, as long as the system can convey the pan from the access opening to the oven chamber. For example, round pegs and holes can be utilized, the slots and cleats can be reversed on the parts, and/or the like.

In this example, the baking pan does not have an integrated handle. Instead, a separate handle 222 is provided that has a grip portion 224 at one end and a pan clip 226 at the other end. The pan clip 226 has a shaped notch 228 as depicted in FIGS. 6 and 7 that is configured to clip onto and under the shorter rim sections 216 of the baking pan 206. The handle 222 can be used to lift and carry the baking pan and to insert or load the pan into the oven 20 and to remove the pan from the oven. The handle 222 including the grip portion 224 and the pan clip 226 can vary from the example disclosed and described herein. The handle 222 can be metal, plastic, or other suitable materials or material combinations and can vary in length, size, grip shape, clip shape, and/or the like.

With reference first to FIGS. 1, 7 and 8, operation and use of the toy baking oven 20 is described below. Though not shown herein, a user can load the baking pan 206 with baking ingredients that are suitable for the toy baking oven 20. Once loaded, the user can attach the handle 222 to the baking pan 206 on one of the shorter rim sections 216. If required for a particular baking operation, the user can first turn the oven on using the knob 34. The knob 34 and control assembly 84 may require the user to select a pre-heating cycle or position to first pre-heat the oven chamber 120 and heating elements 138 to the appropriate temperature. Once pre-heated, the knob 34 and control assembly 84 may need to be reset to a specific baking cycle and/or to set a timer to a specific setting or position. The sophistication of the control assembly 84 will determine the required operation steps for the user to prepare the oven for baking and for a baking process or cycle.

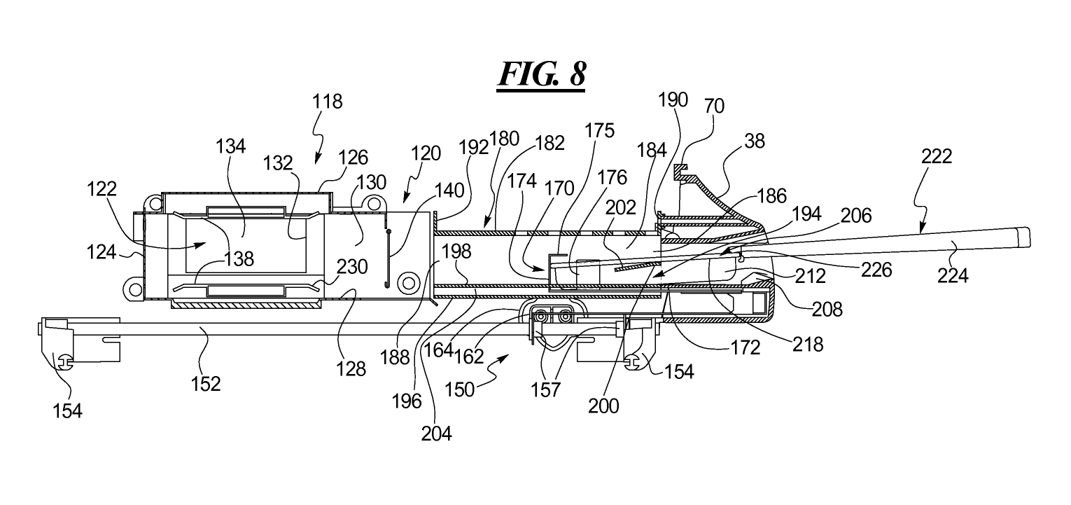

Before or when the oven 20 is ready for baking, the user should move the actuator or handle 164 of the conveyor system 150 on the front 24 of the housing assembly 22 to a home position (see FIGS. 2 and 8) at the end of the slot 160 adjacent the access opening 54 on the side 30. This properly positions components of the conveyor system 150 in a ready to load positon as noted below. The user can then lift the loaded baking pan 206 via the handle 222 and insert or load the pan into the access opening 54 in the oven handle 38 on the side 30 of the oven.

As the user pushes the baking pan 206 into the access opening 54 and the loading region 56, the ramps 208 in the access opening will position and guide the baking pan at the proper height into the oven. The baking pan 206 will first enter the loading region 56 and, in this example, the loading chamber 180 of the conveyor system 150 above the cradle 170. A trailing part of the cradle 170 is under the handle 38 and access opening 54 and a leading part is in the loading chamber 180. The wider rim side sections 218 of the baking pan 206 are guided onto the third flanges 200 of the pan guide 194 in the loading chamber 180. With the conveyor system 150 in the home position, as shown in FIGS. 7 and 8, the leading portions of the sides of the cradle body 172 are seated in the cradle track 204 between the first and second flanges 196, 198 on the loading chamber 180.

The leading end of the baking pan 206 is pushed up against the upstanding wall 174 on the cradle 170, as shown in FIG. 8. The stop flange 175 resides over the leading end of the pan 206. Two of the slots 220 will be positioned over and align with the corresponding cleats 176 on the cradle 170 in this position. The user can release the handle 222 from the baking pan 206 and the pan will tip forward. The trailing end of the pan 206 will still rest on the elevated third flanges 200. However, the cleats 176 will then engage the slots 220 as the leading end of the baking pan 206 drops (see FIG. 8) onto the cradle 170. The user can then begin to slide the actuator or handle 164 along the slot 160 from the home position in a direction toward the oven assembly 118. As the baking pan 206 leaves the third flange 200 in the loading chamber 180, the ramped trailing ends 202 will permit the trailing end of the pan to drop down onto the cradle 170 as well.

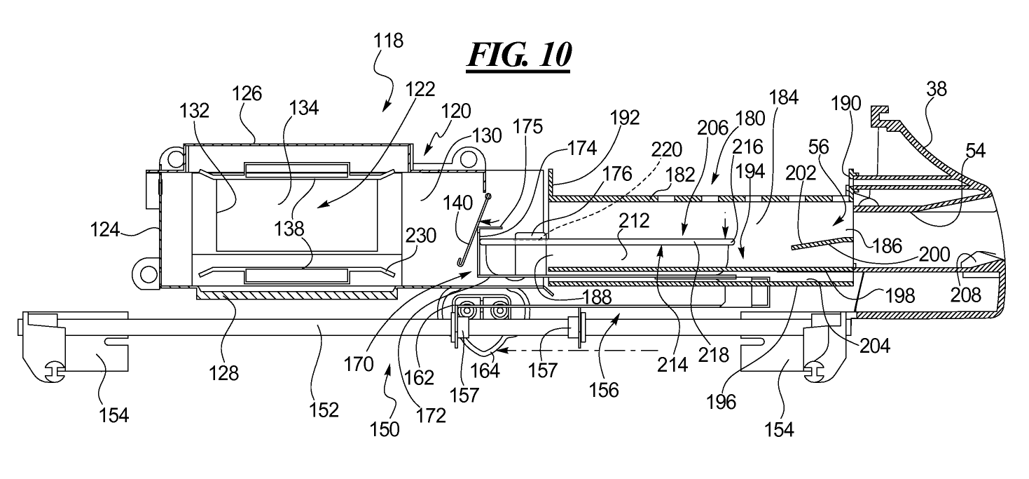

The user can then use the actuator or handle 164 of the conveyor system to deliver the baking pan 206 to the oven chamber 120. The user can slide the handle 164 along the slot 160 away from the access opening 54 toward the opposite left side 28. As this occurs, the shuttle slides along the rod 152, which moves the cradle 170 in the same direction. The cradle 170 conveys the baking pan 206 via engagement of the cleats 176 on the cradle with the slots 220 on the pan, as depicted in FIG. 10. The upstanding wall 174 of the cradle contacts the oven door 140 and swings it upward to the open position, as depicted in FIG. 10.

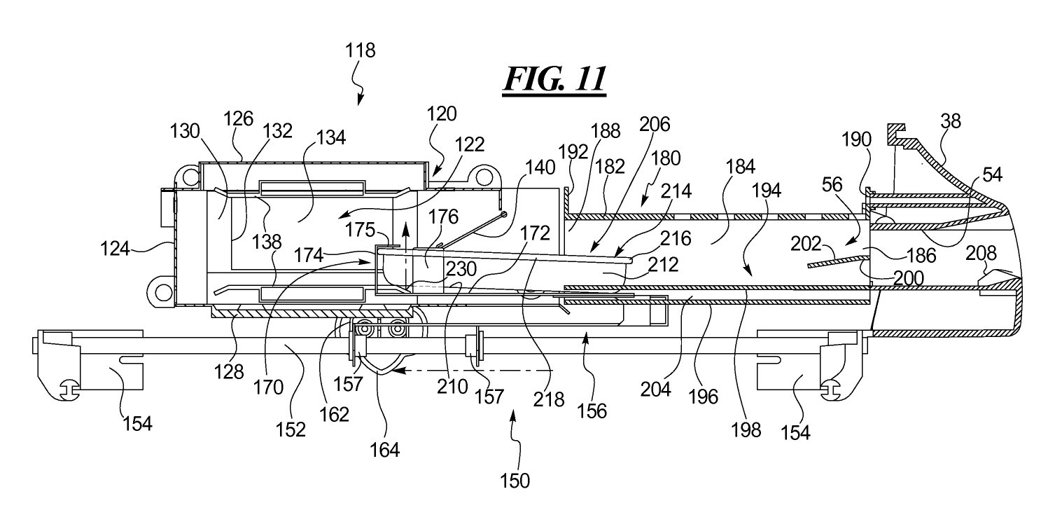

As the user continues to move the handle 164 along the slot 160 further in the direction of the left side 28, the cradle 170 and baking pan 206 enter the interior 122 of the oven chamber 120, as shown in FIG. 11. As this occurs, the cradle 170 and pan 206 encounters a ramp 230 in this example. The ramp 230 can be provided on the bottom wall 128 of the oven chamber 120 or on a part of the lower PTC heating element 138, as in this example. The PTC heating element 138 can be shaped to slightly elevate the baking pan 206 within the oven chamber 120. The elevated PTC element 138 and the ramp 230 can be provided to insure a desired positioning, i.e., specific close vertical spacing or direct contact, between the lower PTC heating element and the baking surface 210 of the pan 206. In one example, the central opening 178 in the cradle 170 can be used to eliminate any intervening barrier between the bottom 210 of the pan 206 and the PTC heating element 138, whether there is direct contact or a gap. In one example, the ramp 230 can elevate both the baking pan 206 and the cradle 170. The thickness of the thin metal body 172 can provide the precise spacing between the PTC material layer of the PTC heating element 138 and the bottom 210 of the pan within the central opening 178, if desired.

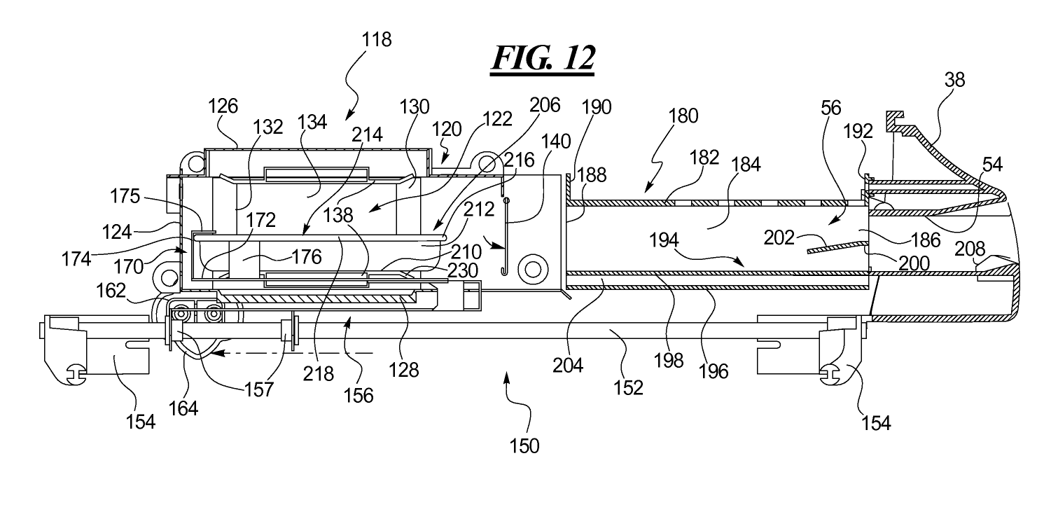

When the handle or actuator 164 reaches the other end of the slot 160, the cradle 170 and baking pan 206 can be centered relative to the PTC heating elements 138, as shown in FIG. 12. Further, the baking surface 210 of the pan 206 is either in direct contact with or very closely spaced from the lower heating element 138 through the cradle's central opening 178. The lower heating element 138 can provide direct and/or indirect heating to the baking pan and the interior 122 of the oven chamber 120. The upper heating element 138 provides additional indirect heating to the interior of the oven chamber. When the baking process is completed, the timer can provide an indication to the user that they can remove the baked ingredients. The control assembly 84 can be configured to ring a bell or produce another audible alarm to inform the user that the baking cycle is done. The user can then reverse the aforementioned process to remove the baking pan 206 from the oven 20. The handle or actuator 164 can be slid back along the slot 160 toward the right side 30 of the housing assembly 22. The cradle 170 and pan 206 will exit the oven chamber 120, again swinging the oven door 140 out of the way. The cradle 170 and pan 206 will move back toward the loading chamber 180. The rim 214 of the pan 206 will ride up the ramped trailing ends 202 of the third flanges 200 on the loading chamber 180. This exposes the trailing end of the rim 214 of the baking pan 206. The handle 222 can be reattached to the baking pan 206 when it reaches the home position. The handle 222 can be used to tilt the baking pan 206 upward to release the slots 220 on the pan from the cleats 176 on the cradle 170. The user can then use the handle 222 to remove the pan from the oven. The baked goods on the pan can then be removed to be further prepared or decorated, if desired, and then eaten.

FIG. 13 shows a top view of the oven 20. The vents 48 in the tray 40 on the top of the oven can provide an additional escape route or exit for excess heat from the oven chamber 120. This can help quickly cool the oven 20 after use. The exiting heat can also be used during baking to warm ingredients for a next baking cycle, if placed in the tray 40 when cold or frozen. The exiting heat can further be used during baking to warm or melt chocolate or other toppings placed in the tray 40. The melted or warmed toppings can then be applied to the baked goods upon being removed from the oven 20. Thus, the tray 40 can act as a warming tray, if desired.

Though not shown herein, the oven 20 can be provided with additional accessories and features. In one example, a serving tray or cookie sheet can be housed within the housing assembly 22 near and either above or below the bottom. A door can be provided on the housing assembly 22 to provide access to a storage space near the bottom for the serving tray or cookie sheet. The light pipe 110 can be configured to direct some light to the indicator opening 90 on the front 24 of the housing assembly. When the light source 104 is illuminated, the light pipe 110 can illuminate the indicator area 90, which will be visible through a portion of the lens 92. This can indicate to the user that the oven is turned on and operational. Alternatively, or in addition, the indicator area can be configured to have a specific design, such as a logo, which can be back lit when the oven is on and operational.

The disclosed toy baking oven 20 can utilize two PTC heating elements, which are far more stable and can reach higher but naturally limited temperatures. PTC heating elements can be configured to heat the oven chamber 120 to 350-360° F. This allows the disclosed oven 20 to actually bake the ingredients to produce baked goods, such as cookies. The PTC heating elements also permit adding back a viewing window into the oven chamber so a user can see as the ingredients bake. PTC heating elements do not throw heat very far, so adding a window to the oven does not result in significant heat loss. This can eliminate the problem with the known new oven designs where the users cannot see the ingredients baking in the oven chamber. The window was a beloved part of the original classic toy baking ovens, but had to be removed when the new wire filament solution was implemented. The disclosed PTC heating element and oven chamber solution has enabled use of a window on the oven and allows kids to again see the ingredients bake.

The nature of a PTC heating element is such that it may work best when there is at least some direct or very close contact with the ingredients to be baked, or at least direct or very close contact with the surface on which the ingredients rest, such as the baking surface of the pan. In other words, the baking surface of the pan should be in direct or very close contact with at least a portion of one of the PTC heating elements in the oven chamber. This is because PTC heating elements do not throw heat very far, as noted above. In the disclosed oven chamber, the two PTC heating elements may be oriented in a specific way, i.e., parallel to one another, and a specific distance apart. This distance can be designed and determined to accommodate a particular oven chamber size and design and/or the needs of a particular toy baking oven application. Inefficiency of heating a relatively large space can be an advantage in the disclosed oven because it may make the overall oven less hot and therefore safer for children.

The disclosed oven chamber can reach an appropriate baking temperature of about 350° F. in about 4-6 minutes. The classic HASBRO® “Easy Bake Oven” takes and recommends about 20 minutes to reach the baking temperature. The wire filament type heating elements that are now used to meet current performance standards still have a pre-heat time of about 20 minutes. This means that kids can go from the box to baking in about one quarter the time using the disclosed toy baking oven compared to the existing toy ovens and the classic toy oven. These prior known baking ovens also cannot or did not achieve temperatures that approach 350° F. so baking of ingredients does not actually take place.

The disclosed toy baking oven also employs a conveyor system to safely and easily guide the baking ingredients both in and out of the oven chamber. The known toy ovens have used and still employ a push stick to move the pan all the way into the oven chamber and back out of the oven chamber when the baking process is done. It is safer and much easier for children to be able to manipulate the pan and ingredients entirely from the exterior of the oven instead of having to manipulate the pan with a stick extended into the oven and all the way into the oven chamber.

The wire filament heating element solution employed by prior known toy baking ovens is substantially safe. However, the elements have to be underpowered in order to make it so. Thus, the wire filament elements take longer to heat up and can only reach a relatively low temperature. The disclosed PTC heating elements are self-regulating in that the elements can only achieve a certain predetermined temperature and can reach the maximum temperature relatively quickly but also in a prescribed amount of time. The PTC heating elements essentially turn on and off as needed due to their increased resistance at higher temperatures in order to maintain the even temperature.

Baking of the ingredients has proven to work best during testing when both direct or very close contact and indirect radiant heat is applied to the ingredients being baked. The disclosed PTC heating elements and the oven chamber arrangement employs both. The top and bottom placement of the PTC heating elements and the close spacing between the elements combine to make the disclosed toy baking oven superior in performance. The cradle has a feature to engage and convey the baking pan to and from the oven and to properly place the pan within the oven chamber. This can also help to keep potentially hot parts of the toy out of the reach of the user because they are not poking a push stick into the oven.

The handle has a pan clip or hook on the end of the handle. The handle can be included with the toy baking oven to help insert and remove the baking pan from the oven but not to position the pan in and remove the pan from the oven. This can also help a user avoid touching a hot pan. The conveyor system can also keep the user away from the access opening during the actual baking process because there is no need to extend a push stick all the way into the oven.

The PTC technology has not been used in a toy oven or baking toy. However, the technology has been proven reliable and consistent in other products. Further, the higher temperatures that can be achieved with the PTC heating elements can produce enough heat to actually bake the ingredients and is enough to brown the ingredients as well. The existing prior art baking ovens can only more or less harden the ingredients but there is very little actual baking and virtually no browning of the ingredients and baked goods. The disclosed PTC heating elements heat up faster and can achieve and maintain a higher but self-regulated temperature much more consistently.

The disclosed toy baking oven can be compatible with baking ingredients such as Girl Scout cookie or other baking ingredient mixes and baked goods mixes. The ingredients can be sold with the oven and can be sold separately as well. Other products may also be compatible with the toy baking oven, such as a Girl Scouts of America Cookie Stand or Cookie Wagon.

Although certain have been described herein in accordance with the teachings of the present disclosure, the scope of coverage of this patent is not limited thereto. On the contrary, this patent covers all embodiments of the teachings of the disclosure that fairly fall within the scope of permissible equivalents.

What is claimed is:

1. A toy baking oven comprising:
a housing assembly;
an oven chamber positioned within the housing assembly and having an interior;
a light source carried by the housing assembly; and
a light pipe between the light source and the oven chamber and arranged to direct light from the light source to the oven chamber to illuminate the interior.

2. A toy baking oven according to claim 1, further comprising one or more heating elements positioned to selectively heat the interior of the oven chamber.

3. A toy baking oven according to claim 2, wherein the one or more heating elements include at least one PTC heating element positioned adjacent the oven chamber.

4. A toy baking oven according to claim 2, wherein the one or more heating elements include two PTC heating elements, one arrange above the interior and one arranged below the interior of the oven chamber.

5. A toy baking oven according to claim 1, further comprising a transparent window on the housing assembly arranged to permit viewing the interior of the oven chamber from an exterior of the housing assembly.

6. A toy baking oven according to claim 1, further comprising a conveyor system disposed between a loading region of the housing assembly and the interior of the oven chamber, the conveyor system operable to convey baking ingredients between the loading region on the housing assembly and the interior of the oven chamber.

7. A toy baking oven according to claim 6, wherein the conveyor system has a handle accessible on an exterior of the housing assembly, the handle being slidable along a slot in the housing assembly to operate the conveyor system.

8. A toy baking oven according to claim 6, wherein the conveyor system has a cradle movable between the loading region and the interior of the oven chamber.

9. A toy baking oven according to claim 1, further comprising a handle on an exterior of the housing assembly, the handle manually operable to convey baking ingredients between a loading region on the housing assembly and the interior of the oven chamber.

10. A toy baking oven comprising:
a housing assembly;
an oven chamber within the housing assembly and having an interior; and
at least one PTC heating element positioned to selectively heat the interior of the oven chamber.

11. A toy baking oven according to claim 10, further comprising at least two of the PTC heating elements, one positioned above the interior and one positioned below the interior of the oven chamber.

12. A toy baking oven according to claim 10, further comprising a light source carried by the housing assembly and a light pipe between the light source and the oven chamber, the light source arranged to direct light from the light source to the oven chamber to illuminate the interior.

13. A toy baking oven according to claim 10, further comprising a transparent window in the housing assembly and arranged to permit visual inspection of the interior of the oven chamber from the exterior of the housing assembly.

14. A toy baking oven according to claim 10, further comprising a conveyor system disposed between a loading region of the housing assembly and the interior of the oven chamber, the conveyor system operable to convey baking ingredients between the loading region and the interior.

15. A toy baking oven according to claim 14, wherein the conveyor system has a handle accessible on an exterior of the housing assembly, the handle being slidable along a slot in the housing assembly to operate the conveyor system.

16. A toy baking oven according to claim 14, wherein the conveyor system has a cradle movable between the loading region and the interior of the oven chamber.

17. A toy baking oven according to claim 10, further comprising a handle on an exterior of the housing assembly, the handle manually operable to convey baking ingredients between a loading region on the housing assembly and the interior of the oven chamber.

18. A toy baking oven comprising:
a housing assembly;
a loading region into the housing assembly;
an oven chamber within the housing assembly; and
a conveyor system operable between the loading region and the oven chamber, the conveyor system having a handle on the exterior of the housing assembly and a cradle within the housing assembly,
wherein the handle is slidable along a slot in the housing assembly to convey the cradle between the loading region and the oven chamber.

19. A toy baking oven according to claim 18, further comprising two PTC heating elements, one arrange above an interior of the oven chamber and one arranged below the interior of the oven chamber.

20. A toy baking oven according to claim 18, further comprising a light source carried by the housing assembly and a light pipe between the light source and the oven chamber, the light source arranged to direct light from the light source to the oven chamber to illuminate an interior of the oven chamber.
